(19) United States
(12) Patent Application Publication
(10) Pub. No.: US 2015/0064552 A1
(43) Pub. Date: Mar. 5, 2015

(54) COMPOSITE ANODE MATERIAL FOR A LITHIUM ION BATTERY AND PREPARATION METHOD THEREOF

(71) Applicants: Dongguan Amperex Technology Limited, Dongguan (CN); Ningde Amperex Technology Limited, Ningde City (CN)

(72) Inventors: Qisen HUANG, Ningde City (CN); Xiang HONG, Ningde City (CN); Kaifu ZHONG, Dongguan (CN); Zhen CHEN, Dongguan (CN)

(21) Appl. No.: 14/450,466

(22) Filed: Aug. 4, 2014

(30) Foreign Application Priority Data
Sep. 2, 2013 (CN) 201310391947.5

(51) Int. Cl. H01M 4/36; H01M 4/04; H01M 4/134; H01M 4/1395; H01M 4/38; H01M 4/62

(52) U.S. Cl. CPC H01M 4/366; H01M 4/386; H01M 4/628; H01M 4/134; H01M 4/1395; H01M 4/0419; H01M 4/0471; H01M 2004/027
USPC 429/212; 427/126.1; 427/558

(57) ABSTRACT

The present invention belongs to the technical field of lithium ion batteries and in particularly relates to a composite anode material for a lithium ion battery. The composite anode material for a lithium ion battery comprises an anode active material and a coating layer coating the surface of the anode active material, wherein the anode active material is at least one selected from the group of Si, SiOₓ or a silicon alloy, the coating layer, which is a polymer of a network structure, accounts for 1-20% by mass of the anode material.

### FIELD OF THE INVENTION

The invention belongs to the technical field of lithium ion batteries and in particular relates to a composite anode material for a lithium ion battery and the preparation method thereof.

### BACKGROUND OF THE INVENTION

At present, the main anode active material for commercial lithium ion batteries is graphite which is limited in gravimetric capacity and can be hardly improved in volumetric capacity and therefore cannot satisfy the demands for use in the future small-volume high-capacity electronic device.

The great amount of research that has been done so far on metal anode reveals that the most promising materials for lithium ion battery are silicon and tin which are nearly four times the tolerable maximum lithium intercalation amount of graphite and therefore have an extremely high volumetric capacity. For example, the theoretical specific capacity of Li_{4.4}Si and Li_{4.4}Sn are up to 4200 mA·h/g and 996 mA·h/g, respectively, and the theoretical volumetric capacity of silicon is even up to 7200 mA·h/cm³. However, an anode active material cracks and drops easily when the volume of silicon/tin is greatly changed during a lithium intercalation/deintercalation process and is therefore likely to lose an electric contact, which undermines the cycle performance of a lithium ion battery and consequentially limits the commercial application of silicon/tin as an anode active material for lithium ion battery.

To address the problem above, a lot of research has been made and a certain improvement has been achieved. For example, the cycle performance of a battery is improved when the electric contact of silicon particles and tin particles is enhanced by nanocrystallizing the silicon particles and the tin particles, however, particles, when reaching a nanometer level, aggregate easily; for another example, the cycle performance of a battery is improved by coating the surfaces of silicon particles and tin particles with carbon (CN1428880A), however, this technique has disadvantages of long operation time, uneven mixing effect, high subsequent thermal processing temperature and high energy consumption; for still another example, the surfaces of silicon particles and tin particles may be coated by a conductive polymer (CN101740748B, CN103078094A and CN102723491A) the use of which guarantees the conductivity of the material but fails to guarantee the ion conduction performance of the material and consequentially causes a severe polarization problem during an electric cycle process, meanwhile, as the mechanical strength (refer mainly to creep resistance and toughness) of the polymer is not taken into consideration, the shrink and swelling of an active material is intolerable during an electrochemical cycle process, and consequentially, the coating layer is ineffective and the active material is exposed in and reacts with an electrolyte, leading to a loss in the capacity of the battery and the deterioration of the cycle performance of the battery.

In view of this, it is indeed necessary to provide a composite anode material for a lithium ion battery, which, with an excellent electron conduction performance as well as an excellent ion conduction performance, guarantees the smooth intercalation or deintercalation of lithium ions into or from an anode material, and the surface of which is coated by a polymer having a superb mechanical strength to inhibit the volume change of an anode active material so that the integrity of the particles of the anode active material is guaranteed and the deformation of an anode is relieved to improve the electrochemical cycle performance of the lithium ion battery and prolong the service life of the lithium ion battery, and a preparation method thereof.

### SUMMARY OF THE INVENTION

One of the purposes of the prevent invention is to address the disadvantages of the prior art with a composite anode material for a lithium ion battery which, with an excellent electron conduction performance as well as an excellent ion conduction performance, guarantees the smooth intercalation or deintercalation of lithium ions into or from an anode material, and the surface of which is coated by a polymer having a superb mechanical strength to inhibit the volume change of an anode active material so that the integrity of the particles of the anode active material is guaranteed and the deformation of an anode is relieved to improve the electrochemical cycle performance of the lithium ion battery and prolong the service life of the lithium ion battery.

To achieve the purpose above, the present invention provides the following technical scheme:

a composite anode material for a lithium ion battery comprises an anode active material and a coating layer coating the surface of the anode active material, wherein the anode active material is at least one selected from the group of Si, SiOₓ or a silicon alloy, wherein 1≦X≦2, and the coating layer, which is a polymer of a network structure, is prepared by crosslinking (a network polymer can be formed through a crosslinking process) polymer precursors having the following structural formula:

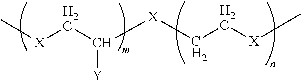

in which X is at least one of O, S and N—R, wherein R is H, an alkyl group having 1-12 carbon atoms, a decenyl group having 2-8 carbon atoms or an aryl group having 6-14 carbon atoms, m is 1-100, n is 10-1000; Y is a reactive silicon group (an active silicon-containing functional group, that is, a silicon group reactive to a cross linking reaction, including a silicon group containing halogen, oxygen, sulfur or nitrogen, as halogen, oxygen, sulfur and nitrogen have a reaction activity to a cross linking reaction, a silicon group containing one of these elements can be called a reactive silicon group), an unsaturated hydrocarbyl containing a carbon-carbon double bond, halogen or a carboxylic acid group. Through the cross linking reaction, the mechanical strength of the coating layer is increased and the solubility of the polymer in a solvent is reduced.

The coating layer accounts for 1-20% by mass of the anode material. If the mass percent of the coating layer is less than 1%, then the particles of the anode active material cannot be completely or uniformly coated to inhibit the swelling of the volume of the active material during a lithium intercalation or deintercalation process, resulting in the breakage of the particles and a degradation in electrochemical cycle performance, on the other hand, if the mass percent of the coating layer is higher than 20%, then the capacity of the battery is decreased, moreover, the ion conduction rate of the battery is also reduced, leading to a severe polarization.

As an improvement of the composite anode material for a lithium ion battery disclosed herein, the polymer is a random copolymer having a weight-average molecular weight of 10,000-5,000,000 and preferably 100,000-1,000,000. If the weight-average molecular weight of the polymer is too high, then the polymer, when in use, can be hardly dispersed uniformly, leading to an uneven coating, on the other hand, if the weight-average molecular weight of the polymer is too low, then the polymer is well dissolved in a solvent and is therefore unlikely to be absorbed on the surface of the anode active material, as a consequence, it is difficult to realize a coating effect.

As an improvement of the composite anode material for a lithium ion battery disclosed herein, the coating layer accounts for 2-10% by mass of the anode material.

With respect to the prior art, the present invention improves the electrochemical cycle performance of a lithium ion battery and prolongs the service life of the lithium ion battery by coating the surface of an active material with a coating layer of a cross-linked network polymer which, with an electron conduction performance as well as an ion conduction performance when being a precursor, guarantees the smooth intercalation or deintercalation of lithium ions into or from an anode active material and, with an excellent mechanical strength endowed by a network structure, keeps the integrity of particles of the anode active material during an electrochemical cycle process and relieves the deformation of an anode. Besides, by means of a cross linking reaction, the polymer is uniformly and firmly coated on the surface of the anode active material in a network form, guaranteeing the performance stability of the material.

The other purpose of the present invention is to provide a method for preparing a composite anode material for a lithium ion battery, comprising the following steps:

a first step: dissolve a polymer precursor in a solvent of water or an organic solvent to obtain a polymer precursor solution, add an anode active material into the polymer precursor solution, stir the mixture to obtain a mixture slurry and adjust the viscosity of the mixture slurry to 300-2000 mPa·s for a too high or low viscosity is unbeneficial to the implementation of spray drying.

a second step: transfer the mixture slurry prepared in the first step to a spray drier to implement spray drying at a drying temperature of 50-150 degrees centigrade to obtain dried particles; through the spray drying, a solution or an emulsion can be directly dried into a powdery or granulated product without being evaporated or crushed, thus reducing the cost.

a third step: implement a cross-linking processing on the obtained dried particles to obtain a composite anode material for a lithium ion battery.

As an improvement of the method for preparing a composite anode material for a lithium ion battery disclosed herein, in the case where Y is a reactive silicon group, the solvent used in the first step is water, and the cross-linking processing refers to spraying the aqueous solution of an organometallic compound onto the surface of the dried particles. In the method, the cross-linking reaction occurs between the reactive silicon group and water, and the organometallic compound is used as a catalyst to enhance reactivity and accelerate the reaction.

As an improvement of the method for preparing a composite anode material for a lithium ion battery disclosed herein, the organometallic compound is dibutyltin diacetate or tetraisopropyl titanium, and the organometallic compound sprayed on the surface of the dried particles accounts for 0.01-2% by mass of the polymer.

As an improvement of the method for preparing a composite anode material for a lithium ion battery disclosed herein, in the case where Y is an unsaturated hydrocarbyl group having a carbon-carbon double bond, a cross-linking agent is also added into the mixture slurry prepared in the first step, and the cross-linking processing in the third step refers to spraying the aqueous solution of a radical initiator to the dried particles, wherein the cross-linking agent is diallyl phthalate, dicumyl peroxide or vinyltriethoxysilane which accounts for 0.01-2% by mass of the polymer, and the radical initiator is an organic peroxide or an azoic compound which accounts for 0.1-5% by mass of the cross-linking agent. The cross-linking agent cross-links the polymer precursors under the initiation of the radical initiator.

As an improvement of the method for preparing a composite anode material for a lithium ion battery disclosed herein, the organic peroxide includes benzoyl peroxide, cyclohexanone peroxide or peroxydicarbonate, and the azoic compound is 2,2′-azodiisobutyronitrile or 2,2′-azobis(2-methylpropionamide)dihydrate.

As an improvement of the method for preparing a composite anode material for a lithium ion battery disclosed herein, in the case where Y is an unsaturated hydrocarbyl group having a carbon-carbon double bond, a photosensitizer, which accounts for 0.01-1% by mass of the polymer, is also added into the mixture slurry prepared in the first step, and the cross-linking processing in the third step refers to irradiating the dried particles with ultraviolet rays. This is a second preparation method in the case where Y is an unsaturated hydrocarbyl group having a carbon-carbon double bond.

As an improvement of the method for preparing a composite anode material for a lithium ion battery disclosed herein, the photosensitizer is diethoxyacetophenone benzoin methyl ether or 2,2-dimethoxy-1,2-diphenylethane-1-one.

As an improvement of the method for preparing a composite anode material for a lithium ion battery disclosed herein, in the case where Y is halogen, a cross-linking agent, which is a polyamine compound, a polythiol compound or a thiourea compound accounting for 0.1-3% by mass of the polymer, is also added into the mixture slurry prepared in the first step, and the cross-linking processing in the third step refers to heating the dried particles at 50-200 degrees centigrade.

As an improvement of the method for preparing a composite anode material for a lithium ion battery disclosed herein, the polyamine compound is ethanediamine, triethylenetetramine or dimethylaminopropylamine, the polythiol compound is 1,10-decanedithiol or 2,3-dithiopyrazine, and the thiourea compound is allylthiourea or thiosemicarbazide.

As an improvement of the method for preparing a composite anode material for a lithium ion battery disclosed herein, in the case where Y is a carboxylic acid group, the cross-linking processing in the third step refers to heating the dried particles at 150-400 degrees centigrade.

As an improvement of the method for preparing a composite anode material for a lithium ion battery disclosed herein, in the case where Y is a carboxylic acid group, a cross-linking agent, which is a polyol compound or a polyamine compound accounting for 0.1-5% by mass of the polymer, is also added into the mixture slurry prepared in the first step, and the cross-linking processing in the third step refers to heating the dried particles at 50-150 degrees centigrade. This is a second preparation method in the case where Y is a carboxylic acid group.

As an improvement of the method for preparing a composite anode material for a lithium ion battery disclosed herein, the polyol compound is hexanediol or propanetriol, and the polyamine compound is triethylenetetramine or dimethylaminopropylamine.

That is, different methods are used to crosslink polymer precursors when Y is different groups (reactive silicon group, unsaturated hydrocarbyl group having a carbon-carbon double bound, halogen or carboxylic acid group).

As an improvement of the method for preparing a composite anode material for a lithium ion battery disclosed herein, the organic solvent is N-methylpyrrolidone.

With respect to the prior art, the present invention, according to which polymer precursors are adhered on the surface of particles of an anode active material through spray drying and then cross-linked to be improved in mechanical strength, is simple in technology and low in cost, moreover, in addition to an excellent electron conduction performance and an excellent ion conduction performance, the anode material prepared using this method also has a relatively high mechanical strength and is therefore capable of keeping the integrity of the particles of the anode active material during an electrochemical cycle process and relieving the deformation of an anode, thereby improving the electrochemical cycle performance of the lithium ion battery and prolonging the service life of the lithium ion battery. Besides, a uniform coating is guaranteed in the method as the surface of the anode active material is coated in a cross-linked manner.

### DETAILED DESCRIPTION OF THE PREFERRED EMBODIMENTS

To make the purpose, the technical scheme and the advantages of the present invention more readily apparent, the present invention is described below in detail with reference to embodiments, and it should be appreciated that embodiments described herein are merely illustrative of, but are not to be construed as limiting the present invention.

The present invention provides a composite anode material for a lithium ion battery.

### Embodiment 1

The composite anode material for a lithium ion battery provided in the embodiment comprises an anode active material Si and a coating layer coating the surface of the anode active material Si, wherein the coating layer, which is a polymer of a network structure, is prepared by crosslinking polymer precursors having the following structural formula:

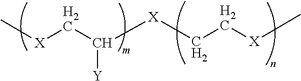

in which X is —NH, Y is propenyl-CH═CH—CH₃, m is 1-100, n is 10-1000, and the weight-average molecular weight of the polymer is 500,000. The coating layer accounts for 5% by mass of the anode material.

### Embodiment 2

The difference of embodiment 2 from embodiment 1 lies in that X is O, Y is —CH₂O(CH₂)₃Si(OCH₃)₃, m is 1-100, n is 10-1000, and the weight-average molecular weight of the polymer is 1000,000. The coating layer accounts for 7% by mass of the anode material.

The other content of embodiment 2 is the same as that of embodiment 1 and is therefore not described repeatedly here.

### Embodiment 3

The difference of embodiment 3 from embodiment 1 lies in that X is O, Y is acrylic acid radical, m is 1-100, n is 10-1000, and the weight-average molecular weight of the polymer is 800,000. The coating layer accounts for 1% by mass of the anode material.

The other content of embodiment 3 is the same as that of embodiment 1 and is therefore not described repeatedly here.

### Embodiment 4

The difference of embodiment 4 from embodiment 1 lies in that X is S, Y is —CH₂—O—CH₂—CH═CH₂, m is 1-100, n is 10-1000, and the weight-average molecular weight of the polymer is 100,000. The coating layer accounts for 10% by mass of the anode material.

The other content of embodiment 4 is the same as that of embodiment 1 and is therefore not described repeatedly here.

### Embodiment 5

The difference of embodiment 5 from embodiment 1 lies in that X is O, Y is Br, m is 1-100, n is 10-1000, and the weight-average molecular weight of the polymer is 350,000. The coating layer accounts for 15% by mass of the anode material.

The other content of embodiment 5 is the same as that of embodiment 1 and is therefore not described repeatedly here.

### Embodiment 6

The difference of embodiment 6 from embodiment 1 lies in that X is O, Y is N-butenyl-CH═CH—CH₂CH₃, m is 1-100, n is 10-1000, and the weight-average molecular weight of the polymer is 3000.000. The anode active material is SiO_{1.6} the surface of which is coated with an amorphous carbon layer which is located between the anode active material and the polymer and accounts for 1% by mass of the anode material, and the coating layer accounts for 20% by mass of the anode material.

The other content of embodiment 6 is the same as that of embodiment 1 and is therefore not described repeatedly here.

### Embodiment 7

The difference of embodiment 7 from embodiment 1 lies in that the anode active material is a silicon-carbon alloy. The other content of embodiment 7 is the same as that of embodiment 1 and is therefore not described repeatedly here.

The present invention also provides a method for preparing a composite anode material for a lithium ion battery.

### Embodiment 8

A method for preparing the composite anode material for a lithium ion battery provided in embodiment 1 is provided in this embodiment, which comprises the following steps:

a first step: dissolve the copolymer (weight-average molecular weight: 500,000) of ethanediamine and 2-propenylethylenimine in deionized water to obtain a polymer solution, add an anode active material Si and 2,2-dimethoxy-1,2-diphenylethane-1-one serving as a photosensitizer into the polymer solution and stir the mixture to obtain a mixture slurry, and adjust the viscosity of the mixture slurry to 1000 mPa·s, wherein the photosensitizer accounts for 0.5% by mass of the polymer.

a second step: transfer the mixture slurry prepared in the first step to a spray drier to implement spray drying at a drying temperature of 100 degrees centigrade to obtain dried particles.

a third step: implement a crosslinking processing on the dried particles obtained in the second step: irradiate the dried particles with an ultraviolet lamp (30 mW/cm², 360 nm) in argon for 30 minutes to crosslink the polymers to obtain a composite anode material coated by the crosslinked polymer, wherein the covering amount is tested to be 5%.

It should be noted that the photosensitizer may also be diethoxyacetophenone benzoin methyl ether.

### Embodiment 9

Another method for preparing the composite anode material for a lithium ion battery provided in embodiment 1 is provided in this embodiment, which comprises the following steps:

a first step: dissolve the copolymer (weight-average molecular weight: 500,000) of ethanediamine and 2-propenylethylenimine in deionized water to obtain a polymer solution, add an anode active material Si and diallyl phthalate serving as a cross-linking agent into the polymer solution and stir the mixture to obtain a mixture slurry, adjust the viscosity of the mixture slurry to 1000 mPa·s, wherein the cross-linking agent accounts for 0.5% by mass of the polymer.

a second step: transfer the mixture slurry prepared in the first step to a spray drier to implement spray drying at a drying temperature of 100 degrees centigrade to obtain dried particles.

a third step: implement a crosslinking processing on the dried particles obtained in the second step: spray the aqueous solution of a radical initiator benzoyl peroxide to the dried particles, keep the obtained product at 25 degrees centigrade for 3 hours to crosslink the polymer, dry the obtained product at 100 degrees centigrade in argon for 5 hours to remove moisture to obtain a composite anode material coated by the crosslinked polymer, wherein the covering amount is tested to be 5%. The radical initiator accounts for 1% by mass of the polymer.

It should be noted that the cross-linking agent may also be dicumyl peroxide or vinyltriethoxysilane, and the radical initiator may also be cyclohexanone peroxide or peroxydicarbonate, 2,2′-azodiisobutyronitrile or 2,2′-azobis(2-methyl propionamide)dihydrate.

### Embodiment 10

A method for preparing the composite anode material for a lithium ion battery provided in embodiment 2 is provided in this embodiment, which comprises the following steps:

a first step: dissolve the copolymer (weight-average molecular weight: 1000,000) of γ-(2,3-epoxypropoxy)propytrimethosysilane and oxirene into N-methylpyrrolidone, stir the mixture into a polymer solution, add an anode active material Si into the polymer solution to obtain a mixture slurry, and adjust the viscosity of the mixture slurry to 800 mPa·s.

a second step: transfer the mixture slurry prepared in the first step to a spray drier to implement spray drying at a drying temperature of 150 degrees centigrade to obtain dried particles.

a third step: implement a crosslinking processing on the dried particles obtained in the second step: spray the aqueous solution of dibutyltin diacetate to the dried particles, keep the obtained product at 25 degrees centigrade for 3 hours to crosslink the polymer, dry the obtained product at 100 degrees centigrade in argon for 5 hours to remove moisture to obtain a composite anode material coated by the crosslinked polymer, wherein the covering amount is tested to be 7%. The dibutyltin diacetate accounts for 1% by mass of the polymer.

It should be noted that the dibutyltin diacetate may also be replaced by tetraisopropyl titanium.

### Embodiment 11

A method for preparing the composite anode material for a lithium ion battery provided in embodiment 3 is provided in this embodiment, which comprises the following steps:

a first step: dissolve the copolymer (weight-average molecular weight: 800,000) of 1,2 epoxy acrylate and oxirene into deionized water, stir the mixture into a polymer solution, add an anode active material Si into the polymer solution to obtain a mixture slurry, and adjust the viscosity of the mixture slurry to 1500 mPa·s.

a second step: transfer the mixture slurry prepared in the first step to a spray drier to implement spray drying at a drying temperature of 120 degrees centigrade to obtain dried particles.

a third step: implement a crosslinking processing on the dried particles obtained in the second step: heat the dried particles at 220 degrees centigrade for 3 hours to crosslink the polymer to obtain a composite anode material coated by the crosslinked polymer, wherein the covering amount is tested to be 1%.

### Embodiment 12

A method for preparing the composite anode material for a lithium ion battery provided in embodiment 3 is provided in this embodiment, which comprises the following steps:

a first step: dissolve the copolymer (weight-average molecular weight: 800,000) of 1,2 epoxy acrylate and oxirene into deionized water, stir the mixture into a polymer solution, add an anode active material Si and a cross-linking agent triethylenetetramine into the polymer solution to obtain a mixture slurry, and adjust the viscosity of the mixture slurry to 1500 mPa·s, wherein the cross-linking agent accounts for 1% by mass of the polymer.

a second step: transfer the mixture slurry prepared in the first step to a spray drier to implement spray drying at a drying temperature of 120 degrees centigrade to obtain dried particles.

a third step: implement a crosslinking processing on the dried particles obtained in the second step: heat the dried particles at 100 degrees centigrade for 3 hours to crosslink the polymer to obtain a composite anode material coated by the crosslinked polymer, wherein the covering amount is tested to be 1%.

It should be noted that the cross-linking agent may also be hexanediol, propanetriol or dimethylaminopropylamine.

### Embodiment 13

A method for preparing the composite anode material for a lithium ion battery provided in embodiment 4 is provided in this embodiment, which comprises the following steps:

a first step: dissolve the copolymer (weight-average molecular weight: 100,000) of dithioglycol and allyl glycidyl ether into deionized water, stir the mixture into a polymer solution, add an anode active material Si and a cross-linking agent dicumyl peroxide into the polymer solution to obtain a mixture slurry, and adjust the viscosity of the mixture slurry to 600 mPa·s, wherein the cross-linking agent accounts for 0.5% by mass of the polymer.

a second step: transfer the mixture slurry prepared in the first step to a spray drier to implement spray drying at a drying temperature of 100 degrees centigrade to obtain dried particles.

a third step: implement a crosslinking processing on the dried particles obtained in the second step: spray the aqueous solution of 2,2′-azodiisobutyronitrile to the dried particles, keep the obtained product at 70 degrees centigrade for 10 hours to crosslink the polymer, dry the obtained product at 100 degrees centigrade in argon for 5 hours to remove moisture to obtain a composite anode material coated by the crosslinked polymer, wherein the covering amount is tested to be 10%, and the 2,2′-azodiisobutyronitrile accounts for 0.5% by mass of the polymer.

### Embodiment 14

A method for preparing the composite anode material for a lithium ion battery provided in embodiment 5 is provided in this embodiment, which comprises the following steps:

a first step: dissolve the copolymer (weight-average molecular weight: 350,000) of epibromohydrin and oxirene into deionized water, stir the mixture into a polymer solution, add an anode active material Si and a cross-linking agent ethanediamine into the polymer solution to obtain a mixture slurry, and adjust the viscosity of the mixture slurry to 1200 mPa·s, wherein the cross-linking agent accounts for 1% by mass of the polymer.

a second step: transfer the mixture slurry prepared in the first step to a spray drier to implement spray drying at a drying temperature of 80 degrees centigrade to obtain dried particles.

a third step: implement a crosslinking processing on the dried particles obtained in the second step: heat the dried particles at 150 degrees centigrade for 2 hours to crosslink the polymer to obtain a composite anode material coated by the crosslinked polymer, wherein the covering amount is tested to be 15%.

It should be noted that the cross-linking agent may also be triethylenetetramine, dimethylaminopropylamine, 1,10-decanedithiol, 2,3-dithiopyrazine, allylthiourea or thiosemicarbazide.

Lithium ion batteries, which are prepared by sequentially implementing procedures including winding, electrolyte injection and formation on an anode which is prepared by adding the composite anode materials prepared in embodiments 1-5 as an anode active material for a lithium ion battery, a binder of butadiene styrene rubber and a conductive agent of superconductive carbon into deionized water in a ratio of 88:10:2, stirring the mixture into a slurry and coating, cold-pressing and slicing the slurry with a corresponding cathode sheet and a separator film, are numbered N1-N5.

As contrast groups, lithium ion batteries number C1 and C2 are also prepared by using pure silicon and amorphous carbon coated silicon as an anode active material according to the aforementioned proportion and procedures.

The aforementioned seven groups of lithium ion batteries are tested in the following way: take four batteries from each group, charge the four batteries to 4.3V at a constant current rate of 1 C at normal temperature, keep the voltage constant until the constant current rate is 0.05 C, place the batteries still for half an hour, discharge the batteries at a constant current rate of 10 until the voltage is 3.0V, and place the batteries still for half an hour, and cycle this process for 500 times.

The capacity retention ratio is calculated, and the lithium ion batteries are disassembled after the cycle test to measure the thickness swelling rate of the anodes, wherein the capacity retention ratio of the Nth cycle=the discharge capacity of the Nth cycle/the discharge capacity of the first cycle*100%, and the result is shown in the following Table 1; the thickness swelling rate of the anode=(the thickness of the Nth cycle—the thickness of uncharged sheet)/the thickness of uncharged sheet*100%, and the result is shown in the following Table 2.

TABLE 1
Capacity retention ratio of different groups
of batteries after 500 times of cycle

| | Capacity retention ratio (%) of batteries | | | | |
|---|---|---|---|---|---|
| | after different times of cycle | | | | |
| Group | 100 times | 200 times | 300 times | 400 times | 500 times |
| N1 | 89 | 85 | 80 | 79 | 70 |
| N2 | 89 | 84 | 81 | 75 | 71 |
| N3 | 88 | 83 | 79 | 72 | 68 |
| N4 | 87 | 86 | 80 | 76 | 72 |
| N5 | 88 | 85 | 79 | 75 | 70 |
| C1 | 85 | Diving | — | — | — |
| C2 | 87 | 81 | Diving | — | — |

TABLE 2
Thickness swelling rate of anodes of different
groups of batteries after 500 times of cycle

| | N1 | N2 | N3 | N4 | N5 | C1 | C2 |
|---|---|---|---|---|---|---|---|
| Thickness swelling rate (%) | 20 | 19 | 20 | 19 | 21 | 200 | 90 |

It can be found from the test result on cycle capacity retention ratio shown in Table 1 that after 500 times of cycle, the capacity retention ratio of batteries N1-N5 using the composite anode material disclosed herein as an anode active material is much higher than that of batteries C1 and C2 using pure silicon or amorphous carbon coated silicon as an anode active material and the swelling rate of anodes corresponding to batteries N1-N5 is much lower than that of batteries C1 and C2 (shown in FIG. 2), which means that the composite anode material provided herein is effectively inhibiting the overall recovery of an anode during an electrochemical cycle process and significantly improves the cycle performance of a lithium ion battery.

Further, it is revealed from the two contrast groups of batteries C1 and C2 that the coating of silicon by amorphous carbon is capable of effectively increasing the cycle capacity retention rate of a battery and relieving the swelling of an anode caused by the volume swelling of silicon particles. However, compared with a battery in which the surface of silicon is coated with amorphous carbon, a battery containing the composite anode material disclosed herein is better in cycle performance and lower in thickness swelling rate due to the relatively excellent ion conduction performance (the polymer precursor of the composite anode material disclosed herein has excellent ion conduction performance) and the relatively excellent mechanical performance of the composite anode material disclosed herein.

Proper variations and modifications can be devised by those skilled in the art on the aforementioned embodiments according to the disclosure and teaching of the present invention. Thus, the present invention is not limited to the specific embodiments disclosed and described above, and the modifications and variations devised based on the present invention should fall into the protection scope of the appending claims. In addition, the terms, as used herein, are merely illustrative of, but are not to be construed as limiting the present invention.

What is claimed is:

1. A composite anode material for a lithium ion battery, comprising an anode active material and a coating layer coating the surface of the anode active material, wherein the anode active material is at least one selected from the group of Si, SiOₓ or a silicon alloy, wherein 1×2, and the coating layer, which is a polymer of a network structure, is prepared by crosslinking polymer precursors having the following structural formula: 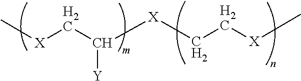
in which X is at least one of O, S and N—R, R is H, an alkyl group having 1-12 carbon atoms, a decenyl group having 2-8 carbon atoms or an aryl group having 6-14 carbon atoms, m is 1-100, n is 10-1000; Y is a reactive silicon group, an unsaturated hydrocarbyl containing a carbon-carbon double bond, halogen or a carboxylic acid group, and the coating layer accounts for 1-20% by mass of the anode material.

2. The composite anode material for a lithium ion battery according to claim 1, wherein the polymer is a random copolymer having a weight-average molecular weight of 10,000-5,000,000.

3. The composite anode material for a lithium ion battery according to claim 1, wherein the coating layer accounts for 2-10% by mass of the anode material.

4. A method for preparing the composite anode material for a lithium ion battery claimed in claim 1, comprising the following steps:
a first step of dissolving a polymer precursor in a solvent of water or an organic solvent to obtain a polymer precursor solution, adding an anode active material into the polymer precursor solution, stirring the mixture to obtain a mixture slurry and adjusting the viscosity of the mixture slurry to 300-2000 mPa·s;
a second step of transferring the mixture slurry prepared in the first step to a spray drier to implement spray drying at a drying temperature of 50-150 degrees centigrade to obtain dried particles; and
a third step of cross-linking the obtained dried particles to obtain a composite anode material for a lithium ion battery.

5. The method for preparing a composite anode material for a lithium ion battery according to claim 4, wherein in the case where Y is a reactive silicon group, the solvent used in the first step is water, and the cross-linking processing refers to spraying the aqueous solution of an organometallic compound onto the surface of the dried particles.

6. The method for preparing a composite anode material for a lithium ion battery according to claim 5, wherein the organometallic compound is dibutyltin diacetate or tetraisopropyl titanium, and the organometallic compound sprayed on the surface of the dried particles accounts for 0.01-2% by mass of the polymer.

7. The method for preparing a composite anode material for a lithium ion battery according to claim 5, wherein in the case where Y is an unsaturated alkyl having a carbon-carbon double bond, a cross-linking agent is also added into the mixture slurry prepared in the first step, and the cross-linking processing in the third step refers to spraying the aqueous solution of a radical initiator to the dried particles, wherein the cross-linking agent is diallyl phthalate, dicumyl peroxide or vinyltriethoxysilane which accounts for 0.01-2% by mass of the polymer, and the radical initiator is an organic peroxide or an azoic compound which accounts for 0.1-5% by mass of the cross-linking agent.

8. The method for preparing a composite anode material for a lithium ion battery according to claim 7, wherein the organic peroxide includes benzoyl peroxide, cyclohexanone peroxide or peroxydicarbonate, and the azoic compound is 2,2′-azodiisobutyronitrile or 2,2′-azobis(2-methyl propionamide)dihydrate.

9. The method for preparing a composite anode material for a lithium ion battery according to claim 4, wherein in the case where Y is an unsaturated alkyl having a carbon-carbon double bond, a photosensitizer, which accounts for 0.01-1% by mass of the polymer, is also added into the mixture slurry prepared in the first step, and the cross-linking processing in the third step refers to irradiating the dried particles with ultraviolet rays.

10. The method for preparing a composite anode material for a lithium ion battery according to claim 9, wherein the photosensitizer is diethoxyacetophenone benzoin methyl ether or 2,2′-dimethoxy-1,2-diphenylethane-1-one.

11. The method for preparing a composite anode material for a lithium ion battery according to claim 4, wherein in the case where Y is halogen, a cross-linking agent, which is a polyamine compound, a polythiol compound or a thiourea compound accounting for 0.1-3% by mass of the polymer, is also added into the mixture slurry prepared in the first step, and the cross-linking processing in the third step refers to heating the dried particles at 55-200 degrees centigrade.

12. The method for preparing a composite anode material for a lithium ion battery according to claim 11, wherein the polyamine compound is ethanediamine, triethylenetetramine or dimethylaminopropylamine, the polythiol compound is 1,10-decanedithiol or 2,3-dithiopyrazine, and the thiourea compound is allylthiourea or thiosemicarbazide.

13. The method for preparing a composite anode material for a lithium ion battery according to claim 4, wherein in the case where Y is a carboxylic acid group, the cross-linking processing in the third step refers to heating the dried particles at 150-400 degrees centigrade.

14. The method for preparing a composite anode material for a lithium ion battery according to claim 4, wherein in the case where Y is a carboxylic acid group, a cross-linking agent, which is a polyol compound or a polyamine compound accounting for 0.1-5% by mass of the polymer, is also added into the mixture slurry prepared in the first step, and the cross-linking processing in the third step refers to heating the dried particles at 20-50 degrees centigrade.

15. The method for preparing a composite anode material for a lithium ion battery according to claim 14, wherein the polyol compound is hexanediol or propanetriol, and the polyamine compound is triethylenetetramine or dimethylaminopropylamine.

16. The method for preparing a composite anode material for a lithium ion battery according to claim 4, wherein the organic solvent is N-methylpyrrolidone.
